(19) United States
(12) Patent Application Publication
(10) Pub. No.: US 2008/0024834 A1
(43) Pub. Date: Jan. 31, 2008

(54) INFORMATION REGISTRATION APPARATUS FOR REGISTERING INFORMATION ONTO REGISTERING DESTINATION ON NETWORK AND METHOD THEREOF

(75) Inventor: Yuma Matsui, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Tokyo (JP)

(21) Appl. No.: 11/777,806

(22) Filed: Jul. 13, 2007

(30) Foreign Application Priority Data
Jul. 28, 2006 (JP) 2006-206722

(51) Int. Cl. H04N 1/04

(52) U.S. Cl. 358/474

(57) ABSTRACT

An apparatus makes determination about a read area of scan data and a registering destination on a network. The apparatus then registers information recorded in the read area onto a registering destination on a network.

### BACKGROUND OF THE INVENTION

1. Field of the Invention

The present invention relates to an apparatus (e.g., scanning apparatus, multifunction peripheral device) which is capable of registering information onto a registering destination on a network, and a method thereof.

2. Description of the Related Art

There is a scanning apparatus which can process scan data. Moreover, there is a system including a scanning apparatus which is connected to a network and performs a process utilizing a server on the network. In such a system, a scan setting can describe the transfer destination of the scanned image data and the process to be performed at the transfer destination (e.g., refer to Japanese Patent Application Laid-Open No. 2000-270148).

However, in a conventional technique, the entire image data is transferred to the server so that the data processing is performed only on the server side. Therefore, it may not be possible to specify a process of high granularity.

### SUMMARY OF THE INVENTION

An embodiment of the present invention is directed to an information registration apparatus which can efficiently process scan data.

According to an aspect of the present invention, an embodiment is directed to an apparatus comprising a determination unit configured to make determination about a read area and a registering destination on a network, and a registration unit configured to register information recorded in the read area onto the registering destination on the network.

According to another aspect of the present invention, an embodiment is directed to a method comprising making determination about a read area, and registering information recorded in the read area onto a registering destination on a network.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a configuration of a scanning system according to an exemplary embodiment of the present invention.

FIG. 2 is a block diagram of a scanning apparatus such as a multifunction peripheral which includes a scanning function according to an exemplary embodiment in the present invention.

FIG. 3 is a block diagram of an example of a hardware configuration of a server according to an exemplary embodiment of the present invention.

FIG. 4 is an example of a standard business form processed by a scanning system according to an exemplary embodiment of the present invention.

FIG. 5 is a flowchart of the entire process of a scanning system according to an exemplary embodiment of the present invention.

FIG. 6 is a flowchart of a process for registering an item indicated in a business form onto a database of an application service provider (ASP) server according to an exemplary embodiment of the present invention.

FIG. 7 is a flowchart of a process for registering an image area indicated in a business form onto a database of an ASP server according to an exemplary embodiment of the present invention.

FIG. 8 is a block diagram to illustrate a method of registering data from a scanning apparatus onto a database of an ASP server according to an exemplary embodiment in the present invention.

FIG. 9 is an example of a description in a scan setting file.

### DETAILED DESCRIPTION OF THE EMBODIMENTS

Various exemplary embodiments, features, and aspects of the invention will be described in detail below with reference to the drawings.

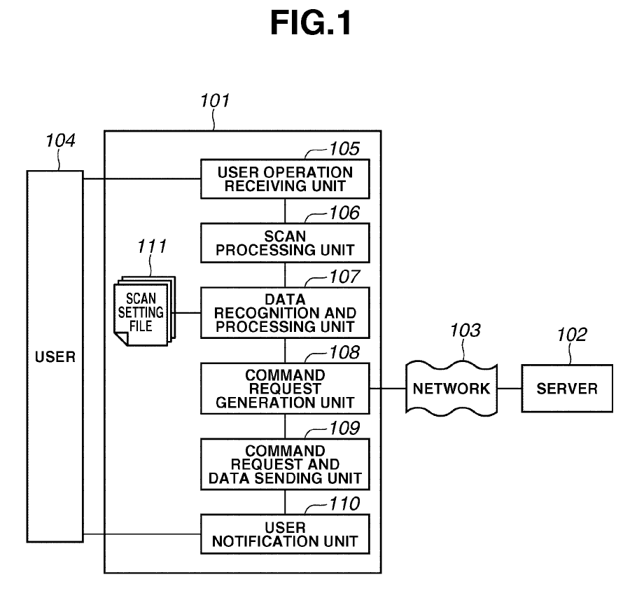

FIG. 1 illustrates a configuration of a scanning system according to an exemplary embodiment of the present invention. An example of a workflow will be described in which a user 104 uses a scanning apparatus 101 to process data of a standard business form while communicating with an application service provider (ASP) server 102 via a network 103.

The scanning apparatus 101 includes an user operation receiving unit 105 and a scan processing unit 106. The scanning apparatus 101 further includes a data recognition and processing unit 107 for recognizing and processing data in one or more areas of the scanned document (e.g., scanned business form), a command request generation unit 108 for generating a command request to a server, a command request and data transmission unit 109, and a user notification unit 110.

A scan setting file 111 describes a collaborative process that is performed by the scanning apparatus 101 and the server 102 in a given area of the scan data. To be more precise, the scan setting file 111 includes a description which specifies an area in the scan data and recognizes the area as an image or a text. Moreover, the scan setting file 111 describes a process to be performed on each recognized data. Furthermore, the scan setting file 111 includes a description about forming a series of process flow by compiling a plurality of processes.

The scanning apparatus 101 determines whether to recognize a specified area in the scan data as an image or text based on the description in the scan setting file 111. In accordance with the determination result, the scanning apparatus 101 recognizes the specified area in the scan data as an image or a text. The scanning apparatus 101 then creates a query for registering data of the image or the text onto a database in the server 102, and sends the query and the data to the server 102.

The server 102 receives the query and the data of the image or the text. The server 102 then interprets the query and stores the data of the image or the text in a database. For ease of description, FIG. 1 illustrates a scanning system with only one server 102. However, a plurality of servers can be included in the scanning system.

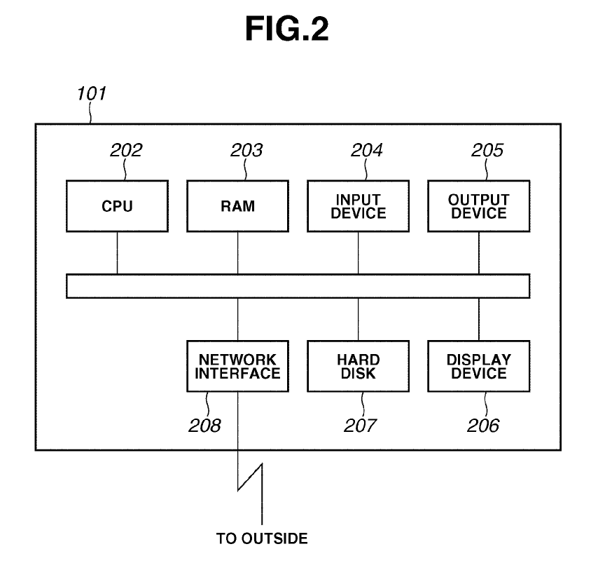

FIG. 2 is a block diagram of a scanning apparatus 101 such as a multifunction peripheral which is provided with a scanning function. Referring to FIG. 2, the scanning apparatus 101 includes following components.

A central processing unit (CPU) 202 controls the entire scanning apparatus 101. A random access memory (RAM) 203 temporarily stores a program or data. A hard disk (HD) 207 is a storage which permanently stores a program or data. The scan setting file 111 in FIG. 1 is stored in either the hard disk 207 or the RAM 203. The CPU 202 reads out a program from the hard disk 207 and executes the program to perform a part of a process concerning a function illustrated in FIG. 1 and/or a flowchart to be described later.

The network interface 208 is an adaptor that communicates with the outside through the network 103. An input device 204, such as an operation panel, is a device for receiving input from the outside. An output device 205, such as a printer, is a device for making output to the outside. A display device 206 is, for example, a screen. The scanning apparatus may not include all of the components described in FIG. 2, or can include other components. The components described in FIG. 2 are those that are typically included in computers.

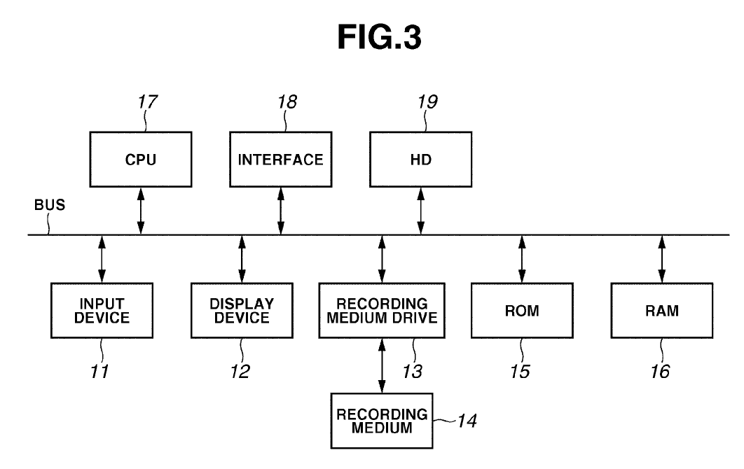

FIG. 3 illustrates an example of a hardware configuration of a server 102. As shown in FIG. 3, the server 102 includes an input device 11, a display device 12, a recording medium drive 13, a read-only memory (ROM) 15, a RAM 16, a CPU 17, an interface 18, and an HD 19.

The input device 11, such as a key board or a mouse, is used by an operator of the server 102 to input various operation information into the server 102. The display device 12 is a display utilized by the operator, and displays various information (or screens). The interface 18 connects the server 102 to the network 103.

A program for realizing the functions of the server 102 is supplied from a recording medium 14 such as a CD-ROM to the server 102, or is downloaded onto the server 102 through the network 103. The recording medium 14 is set in the recording medium drive 13, and the program is installed in the HD 19 from the recording medium 14 through the recording medium drive 13. The program can also be pre-installed in the HD 19.

The ROM 15 records a program that is first read in when the server 102 is switched on. The RAM 16 is the main memory of the server 102. The CPU 17 reads out a program from the HD 19, stores the program in the RAM 16, and executes the program as necessary to provide all or part of the functions of the server 102. In addition to the programs, the HD 19 can store, for example, a database. The server may not include all of the components described in FIG. 3, but can include other components. The components described in FIG. 3 are those that are typically included in computers.

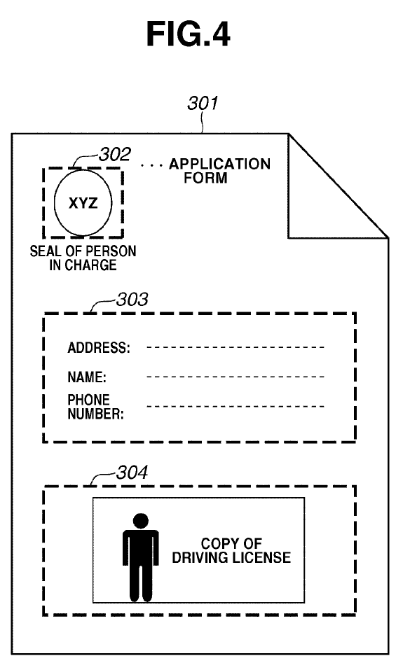

FIG. 4 is an example of a standard business form to be processed by a scanning system according to an exemplary embodiment. In the example of FIG. 4, the standard business form 301 includes a verification image area 302, a business form item area 303, and a business form image area 304. The verification image area 302 is used in a verification of an image such as a seal (or a signature). The business form item area 303 is recognized as text data by performing an optical character recognition (OCR) and is registered onto a database in the ASP server 102. The business form image area 304 is stored as an image file in a database of the ASP server 102.

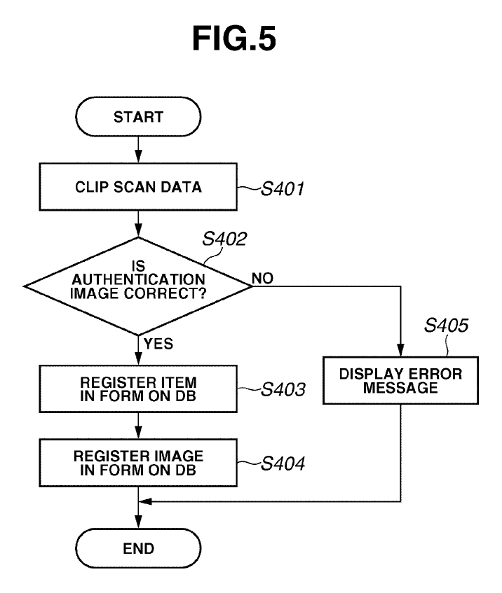

FIG. 5 is a flowchart of a process of a scanning system according to an exemplary embodiment. In step S401, the scanning apparatus 101 clips scan data. To be more precise, in an embodiment, a rectangular area to be clipped out of the scan data is previously specified in the scan setting file 111. Accordingly, the scanning apparatus 101 clips out the specified rectangular image data (e.g., corresponding to the verification image area 302, business form item area 303, and business form image are 304) from the original scan data.

In step S402, the scanning apparatus 101 conducts a verification process by utilizing a verification image corresponding to the verification image area 302 in the standard business form. In this process, the scanning apparatus 101 determines whether the verification image such as a seal (or a signature) affixed on the business form matches the previously registered verification image to confirm the authenticity of the business form. The verification of an image included in the verification image area 302 can also be performed by an external server 102.

In the case where the verification is unsuccessful (NO in step S402), the process proceeds to step S405, and the scanning apparatus 101 displays an error message. The process in FIG. 5 then ends. On the contrary, if the verification is successful (YES in step S402), the process proceeds to step S403. In step S403, for example, the scanning apparatus 101 registers the data obtained by performing an optical character recognition (OCR) on an item affixed to the business form, onto the database in the ASP server 102. In step S404, the scanning apparatus 101 then registers the image area included in the business form as data onto the database in the ASP server 102. The above processes will be described in detail later.

The databases in step S403 and in step S404 can be different databases of the same ASP (i.e., in the same server). Alternatively, the databases can be those of different ASPs (i.e., stored in different servers).

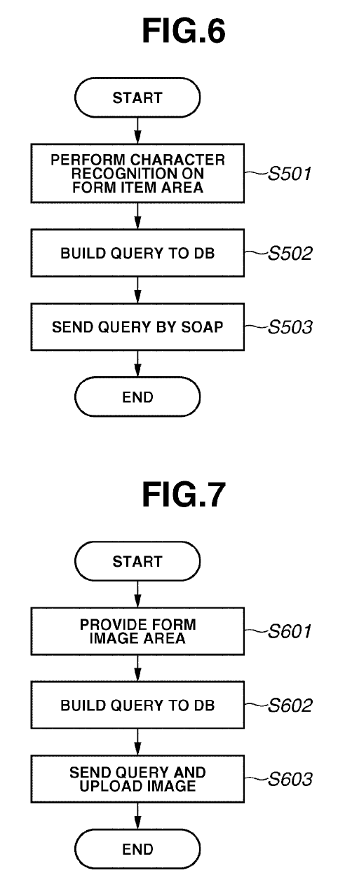

FIG. 6 is a flowchart of a process (step S403) for registering an item (e.g., information recorded in a read area) included in a business form onto a database in an ASP server 102. In step S501, the scanning apparatus 101 performs character recognition on a specified area (e.g., business form item area 303) in the business form. By performing such a process, written items in the business form can be retrieved as text data.

In step S502, the scanning apparatus 101 builds a query for registering business form item data onto the database of the ASP server 102 according to the description in the scan setting file 111. In step S503, the scanning apparatus 101 utilizes a web service protocol such as a Simple Object Access Protocol/Hypertext Transfer Protocol (SOAP/HTTP) to send a query to the ASP server 102 which has an interface for a web service. The ASP server 102 registers the data onto the database according to the received query.

FIG. 7 is a flowchart of registering an image area included in a business form onto a database in an ASP server 102 (i.e., the process in step S404). In step S601, the scanning apparatus 101 stores as an image file an image area included in the business form (business form image area 304) which is clipped out from the scan data.

In step S602, the scanning apparatus 101 builds a query for registering the business form image data onto a database in the ASP server 102 according to the description in the scan setting file 111. In step S603, the scanning apparatus 101 utilizes a web service protocol such as SOAP/HTTP to send a query to the ASP server 102 which has a web service interface, and upload the image file. The ASP server 102 registers the image file on the database according to the received query.

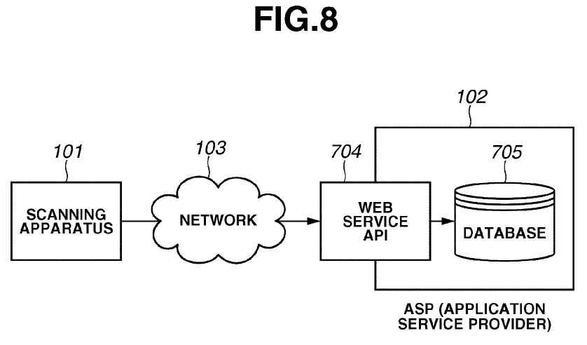

FIG. 8 is a block diagram to illustrate the method of registering data from the scanning apparatus 101 onto the database in the ASP server 102. The scanning apparatus 101 sends the data to the ASP server 102 through the network 103 utilizing a web service such as SOAP. The ASP server 102 receives the data from a web service Application Programming Interface (API) 704 and registers the data on the internal database 705 in accordance with the received data. Next, a description of the scan setting file 111 and a process according to the description are explained.

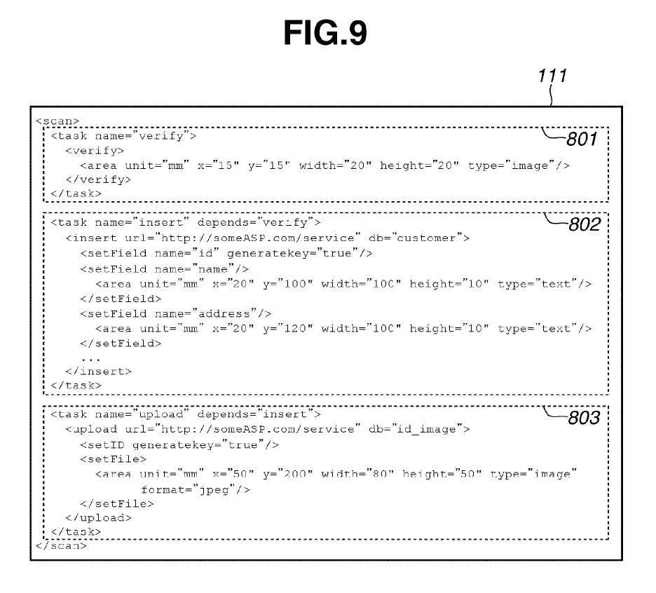

FIG. 9 is an example of the description in the scan setting file 111. In FIG. 9, the scan setting file 111 is described in the Extensible Markup Language (XML). The main elements in the scan setting file 111 will be described below.

The element “area” indicates an area in the business form. The attribute “unit” indicates a unit of length. The attributes “x” and “y” indicate the coordinates of the upper-left vertex of a rectangular area, and “width” and “height” indicate the width and height of the rectangular area respectively. Moreover, the attribute “type” specifies whether the object area is recognized as an image or text, and “format” specifies the format for storing the file.

The element “task” indicates a group of processes. The attribute “name” specifies the name of the task, and “depends” specifies the name of a task that constitutes the condition for performing the task. In a task 801 described in FIG. 9, the element “verify” indicates an image verification process in the present exemplary embodiment.

In a task 802 described in FIG. 9, the element “insert” indicates adding a record onto the database in the ASP server 102. The attribute “url” indicates the Uniform Resource Locator (URL) of a web service server 102, and the attribute “db” indicates the database on which the data is to be registered.

In a task 803 described in FIG. 9, the element “upload” indicates uploading of a file. Similar to the element “insert”, the attribute “url” indicates the URL of the web service server 102, and the element “db” indicates the database on which data is to be registered. Other elements such as “setField”, “setID”, and “setFile” are used to specify information that is required to build a query to register the data. An attribute generatekey=“true” described in the elements “setField” and “setID” indicates generating and setting of a common and unique key through one scanning process.

The flow in which the scan setting file 111 is read and the process is performed will be described by referring to the task “insert” in the task 802 as an example. Since the task “verify” is specified in the attribute “depends” of the element “task”, the task “insert” will not be executed unless the task “verify” ends normally. That is, if the verification is successful, the scanning apparatus 101 proceeds to execute the next “insert” process. However, if the verification is unsuccessful, an error message is notified and the process ends.

In the case where the process is executed, the scanning apparatus 101 registers the data onto the ASP server 102 in accordance with the “insert” command. In this example, the data is registered by building and sending the query to a database “customer” in the server 102 of an ASP (e.g., the URL http://someASP.com/service) which provides a web service.

The query for registering data is built by specifying a value that is to be set to a specific field on a database through a “setField” command. In the example, since the attribute “type” in the element “area” of the target area is “text”, the scanning apparatus 101 performs an OCR on the specified area in the business form, and a specific value is retrieved as text data.

As a result, in performing the task “insert”, a series of processes, i.e., word recognition by OCR, building of a query, and sending of a query to the ASP server 102, are automatically performed. Consequently, the necessary information is registered in the database.

As described above, the scan setting file 111 can be used to describe the contents of a process flow and how the process is to be automatically executed on data in a specific area included in a standard business form.

The present invention can also be achieved by providing a storage medium which stores software (program code) for realizing the operations of the above-described exemplary embodiments, to a system or an apparatus. In the above case, the program code itself realizes the operations of the embodiments. The storage medium which stores the program code constitutes the present invention.

Furthermore, the above embodiments are realized by executing the program codes which are read by a CPU. The present invention includes a case where an OS (operating system) or the like running on the computer performs a part or entire processes in accordance with designations of the program codes and realizes functions according to the above embodiments.

Furthermore, the supplied program code can be stored in a memory equipped in a function enhancement board of the computer or a function enhancement unit connected to the computer, and a CPU in the function enhancement board or the function enhancement unit can execute all or part of the processing based on the instructions of the program code to realize the operations of the embodiments.

In the case where the present invention is applied to the recording medium, the storage medium stores the program corresponding to the flowchart described in the exemplary embodiments.

According to the above-described exemplary embodiments, an area in scan data can be specified during scanning, and a unique process can be performed on each area. Moreover, the data processing can be performed not only on the server side but the scan apparatus side, and performed collaboratively by both the server and the scanning apparatus. As a result, the scan data can be processed efficiently.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-206722 filed Jul. 28, 2006, which is hereby incorporated by reference herein in its entirety.

What is claimed is:

1. An apparatus comprising:
a determination unit configured to make determination about a read area and a registering destination on a network; and
a registration unit configured to register information recorded in the read area onto the registering destination on the network.

2. The apparatus according to claim 1, wherein the determination unit determines whether the information recorded in the read area is a text or an image.

3. The apparatus according to claim 1, wherein the determination unit determines a position at which a verification image is recorded, and a position at which information to be registered is recorded when verification is successful.

4. The apparatus according to claim 1, further comprising:
a scanning unit configured to scan a document to generate scan data, wherein the read area comprises a defined area of the scan data.

5. The apparatus according to claim 4, further comprising:
a data recognition unit configured to perform character recognition on the read area of the scan data to extract text data, wherein the information registered by the registration unit comprises the text data extracted from the read area of the scan data.

6. A method comprising:
making determination about a read area of scan data; and
registering information recorded in the read area onto a registering destination on a network.

7. The method according to claim 6, wherein making determination comprises determining whether the information recorded in the read area is a text or an image.

8. The method according to claim 6, further comprising determining a position at which a verification image is recorded, and a position at which information to be registered is recorded when verification is successful.

9. The method according to claim 6, further comprising:
performing character recognition on the read area of the scan data to extract text data, wherein the registered information comprises the text data extracted from the read area of the scan data.

10. A computer-readable recording medium storing instructions which, when executed by an apparatus, causes the apparatus to perform operations comprising:
making determination about a read area of scan data; and
registering information recorded in the read area onto a registering destination on a network.

11. The computer-readable recording medium according to claim 10, wherein the operations further comprises:
determining whether the information recorded in the read area is a text or an image.

12. The computer-readable recording medium according to claim 10, wherein the operations further comprises:
determining a position at which a verification image is recorded, and a position at which information to be registered is recorded when verification is successful.
